(19) United States
(12) Patent Application Publication
(10) Pub. No.: US 2018/0238096 A1
(43) Pub. Date: Aug. 23, 2018

(54) Method and mechanism for the control of a door, primarily sliding door

(71) Applicants: Viktor Liberda, Wien (AT); Rudolf Liberda, Wien (AT)

(72) Inventors: Viktor Liberda, Wien (AT); Rudolf Liberda, Wien (AT)

(21) Appl. No.: 15/895,961

(22) Filed: Feb. 13, 2018

(30) Foreign Application Priority Data
Feb. 14, 2017 (AT) 50118/2017

(51) Int. Cl. E05F 15/46; E05F 15/43; E05F 15/646

(52) U.S. Cl. CPC E05F 15/46; E05F 15/43; E05F 15/646; E05Y 2201/246; E05F 2015/483; E05Y 2400/33; E05Y 2400/858; E05Y 2400/554; E05Y 2400/44

(57) ABSTRACT

For controlling a door driven by a motor, in particular a sliding door, the capacitances of at least two capacitive sensor electrodes arranged on a front surface of a door panel of the door are determined independently from one another with regard to a common reference potential, preferably a ground potential. If a change of capacitance for at least one of the sensor electrodes in comparison with at least one further sensor electrode is determined, a signal to stop the motor is generated.

### CROSS REFERENCE TO RELATED APPLICATIONS

This application claims priority to Austrian Application No. 50118/2017 filed on Feb. 14, 2017, the disclosure of which is hereby incorporated by reference in its entirety.

### FIELD AND BACKGROUND OF THE INVENTION

The invention relates to a method for the control of a door driven by a motor, in particular a sliding door, as well as a mechanism for controlling such a door.

### SUMMARY OF THE INVENTION

The invention regarded here is generally suitable for motor-driven doors of all types, and primarily sliding doors; in addition, rolling doors, sectional doors, lift gates, and if necessary also revolving doors come into consideration. Motor-driven doors are widespread and find use in many areas. For example, if gate systems usable by motor vehicles as base pieces are frequently implemented with motorized doors, in particular with gate systems of particularly large dimensions, as for example sliding doors or sliding gates for garages, passages in shopping centers or airplane hangars, in general, the moving parts of the doors/gates are driven by a motor for opening and closing.

In more expedient fashion, these systems are provided with means to recognize obstacles in the displacement path of the motorized sliding door, whereby the presence of an obstacle in the displacement path leads to the immediate stop and if necessary to a new, partial or complete opening of the sliding door. Traditionally, the mentioned means for the contactless recognition of obstacles in the displacement path of the motorized sliding door are implemented as visual safety elements such as light barriers or light curtains, such that also the entry of an obstacle, for example, a person, will lead to a disruption or stop signal for the drive, even if the person crosses the displacement path far removed from the door edge and thus is overall not endangered by the closing movement of the sliding door. For large gate systems, such as the mentioned hangar gates, this can under certain circumstances result in the gate practically no longer fully closing in normal operation, because, during the act of closing, which, because of the size and the weight of the sliding door can take a certain amount of time, almost inevitably there will be persons who cross over into the displacement path, and a sliding door generally overseen, for example, with light curtains, will stop whenever there is an entry by a person or another vehicle and will then proceed back to an open position.

The present invention thus underlies the task of generating a control of a motorized (sliding) door, in which the brief entry of persons, vehicles, or small objects does not automatically lead to the stopping of the motor; instead, with a correspondingly sufficient distance of the person, vehicle, or a similar object, the closing movement or the motor for closing and opening the door does not stop, but nevertheless a contactless recognition of obstacles is ensured. Principally, for this, procedures including capacitive detection of obstacles are a good choice, because these—different than light barriers—capture only a certain area around the center; nevertheless, capacitive procedures are in large part vulnerable to environmental influences such as humidity, dust, contamination, and similar items, which is why up to now they have not been able to be implemented commercially.

To resolve the task presented above, the method according to the invention is characterized in that the capacitances of at least two capacitive sensor electrodes arranged on the door edge of the sliding door are detected against ground potential or a common reference potential (e.g. those of the door panel or the doorframe) and, in the establishment of a difference between the capacitance of at least one of the sensor electrodes in comparison to at least one further sensor electrode, a signal to stop the motor, for example in a computing or control unit, is generated. For example, it is possible that, in quick succession, the capacitances of two sensor electrodes at a time are compared with one another through subtraction, for example several times per second, preferably 50 times to 500 times per second. On the one hand, through the use of capacitive sensor electrodes, the already outlined disadvantage of light barriers is eliminated, because only one obstacle in the area of the sensor electrodes will lead to a detection. Nevertheless, because of the fact that not just one, but instead several sensor electrodes, that is, at least two sensor electrodes, are provided on the door edge, and because of the fact that the capacitances of these sensor electrodes are determined with respect to ground independently of each other, the presence of an obstacle or a person in the area of the door edge can be recognized, because only capacitance differences to at least two sensor electrodes will lead to the generation of a stop signal. If the door nevertheless approaches its closed position, the capacitances of all sensor electrodes are changed at the same time by the inlet profile, and no stop signal is generated. The same goes for capacitance changes on all sensor electrodes due to environmental influences, such as, for example, through changes in humidity: the capacitances of all sensor electrodes change concurrently, and no stop signal is generated. Thus, the method according to the invention achieves that a motorized sliding door will stop only if there is actually an obstacle in the danger area in front of the door edge, such that even large sliding doors can also be driven into the closed position even if potential obstacles are found to be at a certain distance removed from the door edge in the displacement path. As long as this will not result in a dangerous convergence of the obstacle toward the door edge, the door will continue to close, such that, overall, the probability increases of finding automatic doors closing in an orderly fashion in a heavily frequented work area.

Likewise, the invention provides a control mechanism for a sliding door driven by a motor, with at least two capacitive sensor electrodes on a door edge of the sliding door and with instruments (measurement devices) to determine the potential of at least two capacitive sensor electrodes independent of one another to ground; and further devices (e.g. a sensor or a microprocessor) are intended to generate a signal to stop the motor with the establishment of a capacitance change to at least one of the sensor electrodes in comparison to at least one further sensor electrode. The advantages of this mechanism and their further development correspond to those which are discussed above in connection with the method of the invention.

In accordance with a preferred embodiment of the invention, the capacitive sensor electrodes can be operated with an operating current of 150 kHz to 400 kHz, preferably 200 kHz to 300 kHz. Nevertheless, in general, the frequencies are selectable in a further area between 10 kHz and approximately 5 MHz. With these frequencies, a sufficiently large number of measurement values can be generated, which are condensed by the control unit into an easily usable average value, and thus the best possible balance between the extension of the sensitive area and the low susceptibility to disturbance of the electrodes can be achieved.

In favorable fashion, the method according to the invention may be implemented in such a way that the capacitive sensor electrodes on the door edge are arranged on top of each other as stripes at a distance from each other made of electrically conductive material, preferably metal, on an insulating layer, e.g. made of plastic material. The insulating layer must be stable with regard to its relative permittivity, and thus may not include any water; lower values of the permittivity value are desirable to keep the occurrence of disruptive stray capacitances low.

The permittivity value should therefore amount to 6 at most, preferably between 1 and 4, and preferably at most 3. An insulating level made of polyethylene of Teflon can be produced cheaply and ensures a reliable insulation of the electrodes across the door edge. The insulating level may also consist of a hard-based material, such as, for example, FR4, or another epoxy resin with a glass fabric insert.

According to one suitable embodiment of the invention, the method of the invention may be further developed in such a way that the capacitive sensor electrodes on the door panel (or, more exactly, the body of the door panel) are spatially and electrically separated from one another by at least one guard electrode. For example, on their sides facing the door edge, they may be encompassed by a controlled guard electrode separated by insulation, which guard electrode is, for example, designed with a U-shaped cross section. In addition, on the sides of the U-shape, preferably on the base of the U, protruding edges may be provided; the edges are preferably arranged symmetrically and, along with the U-form, yield the width of the door panel. Alternatively, the guard electrode may be flat, with a width that is the same as or smaller than the width of the door panel, where the sensor electrodes are integrated into the door edge. This means that the sensor electrodes are surrounded by the guard electrode primarily from behind, that is, on the side facing the door, or on the sides and from behind, that is, on the side facing the door.

The guard electrode may be operated favorably with the same phase and amplitude as the sensor electrodes, preferably from the same source. The controlled guard electrode ensures, on the one hand, that the capacitances of the sensor electrodes from the side facing the door and, likewise, from the sides, that is, from those sides which are irrelevant for the capture of possible obstacles, are much less influenceable in such a way that error detections can be prevented. On the other hand, a suitably chosen geometry of the guard electrode and, in particular, the edges protruding on the side, achieves a shaping of the field line pattern of the sensor electrodes, so that, overall, the area of the capture of obstacles by the sensor electrodes can be increased or adjusted.

A sensor with such a guard electrode will preferably be effective in prolongation of the door plane level. To be able to capture obstacles that are to be found even to the side of the door plane level with the sensor, a guard electrode may be chosen that is as wide as the sensor. To more strongly extend the side field, the sensor electrode may be realized flat or slightly curved; in addition, it may be provided with short legs on the side, protruding in the direction of the guard electrode, preferably 1 to 5 mm long.

The capacitance measurement takes place with reference to a common reference potential, in general toward the ground, and is thus variably sensitive, based on whether the sensor is mounted on a door panel made of an electrically conductive or a non-electrically conductive material. Door panels made of metal or another conductive metal frequently limit the sensitivity of the measurement. To balance off this effect, it is frequently favorable if the measurement device is capacitively well-grounded via an element made of conductive material, preferably via metal strips with some distance to the sensor electrodes laid on these. This coupling element is preferably arranged on another door edge (e.g. the upper and/or the lower) than the door edge of the sensor electrodes, and yields, through the capacitive coupling of the door panel to the ground potential, a stabilization of the capacitance measurement. Furthermore, it is an advantage if the controlled guard electrodes are well isolated from the conducting doors and are attached with a larger distance than with the non-conductive door panels, preferably larger than 15 mm or 10 to 20 mm in one area (if necessary, up to 50 mm). With non-conductive door panels, by contrast, in general, lesser distances are possible, typically under 10 mm, for example, with 4 mm±1 mm.

The present invention may preferably be further developed in that a control unit is configured to generate the signal to stop the motor, as well as to preferably differentiate a capacitance change caused by water from other obstacles and to transmit them to a control unit for the motor wirelessly.

A preferable variant of the present invention provides that the components for the control of the motorized sliding door, in particular the sensor electrodes, the guard electrodes, and the insulating layer, will be arranged on one carrier element; the sensor electrodes as well as the guard electrodes (if present) and further components, will be arranged on the carrier element, which is attached to a door edge. This will make it possible to prefabricate the detection mechanism of the invention and to mount it on an existing door, in particular a sliding door, without great expense. In this way, a retrofitting with an invention mechanism for the carrying out of the method of the invention will be made possible.

To reduce the sensitivity with regard to external disruptions (electromagnetic compatibility), it may also be favorable to have the sensor electrodes run across the entire height of the front surface. Each of the sensors may hereby have varying width along the height and in differing ways from the other sensor electrodes. Alternatively or in combination with this, in each of the sensor electrodes, slim areas (that is, areas with negligible width) with at least two electrode surfaces may alternate. Here, “height” means the coordinate of the longitudinal direction of the door edge, regardless of the possible actual orientation of the doors; for the most part, however, the door edge is oriented along the vertical.

In an embodiment with sensor electrodes running along the entire height or at least one height area, it may also be favorable if on at least one end area of the front surface, the sensor electrodes all have the same width; this allows a possible shortening of the sensor electrodes, namely, at the end area (if necessary, also on both end areas) and by a length of shortening of up to a certain maximum amount of shortening. Hereby, the adjustment of a sensor device (e.g. prefabricated with a prescribed length amount) to the actual dimension of height of the door edge can be facilitated.

In an advantageous realization of the invention, the control system comprises, at the door panel, a sensor device that is (only) wirelessly connected. This sensor device is connected with the control unit via a wireless interface, using which the values of the capacitances and/or capacitance differences are transmitted wirelessly by the sensor device. In addition, the energy supply of the sensor device may take place via the wireless interface, for example, via a radio or infrared signal. The energy supply may also take place via an inductive connection when the door is in closed condition.

To reduce the energy consumption on the part of the sensor device, which includes the capacitive sensor electrodes on the part of the door panel, and in particular, in the case of a wireless sensor device, to increase the lifespan of the energy storage system provided there (batteries or accumulators), it is favorable to activate the sensor device (only) for the length of one door movement of the door. For this purpose, it is possible to send signals—e.g. control signals for activity control—to the sensor device at appropriate points in time, in particular at the beginning and at the end of a door movement (again, if applicable, wirelessly), in order to activate the sensor device for the length of the door movement; after this, the sensor device is deactivated.

### BRIEF DESCRIPTION OF THE DRAWINGS

The invention is explained in more detail in the following using several embodiments, which are presented in the attached diagrams and which are intended to illustrate the invention in exemplary fashion, without limiting the invention. The diagrams show, in schematic form:

FIG. 1 a perspective view of a sliding door including a first embodiment of the control system of the invention;

FIG. 2 a frontal view of the door edge of the door panel of the sliding door of FIG. 1 and, specifically, the sensor device of the control system;

FIG. 3 a side view of the sensor device in FIG. 2;

FIG. 3a an enlarged detail of the sensor device corresponding to detail A of FIG. 3;

FIG. 4 an enlarged top view of the door edge and the sensor device;

FIG. 4a the components of the sensor device in blown-up presentation;

FIG. 5 the components of a variant of the sensor device in an exploded top view;

FIG. 6 a sectional view of the sensor device, depicting the geometry of a typical field line distribution;

FIG. 7 a sectional view of a further embodiment with a guard electrode with projections;

FIGS. 8a-8k further configurations of the electrodes of the sensor device in like sectional views;

FIG. 9 a block diagram of the control system of the first embodiment;

FIG. 10 a block diagram of a control system with wireless connection of the sensor device;

FIG. 11 a block diagram of a variant having several groups of sensor electrodes;

FIG. 12 a frontal view of a further embodiment of a sensor device, which also allows for shortening;

FIG. 13 a side view of the sensor device in FIG. 12;

FIG. 14 a top view of the sensor device in FIG. 12; and

FIG. 15a-15e further configurations of electrode arrangements on the front surface, in each case in frontal view.

### DISCLOSURE

It shall be understood that the present invention is not limited to the shown embodiments, but rather also includes many modifications and arrangements within the scope of the appended claims.

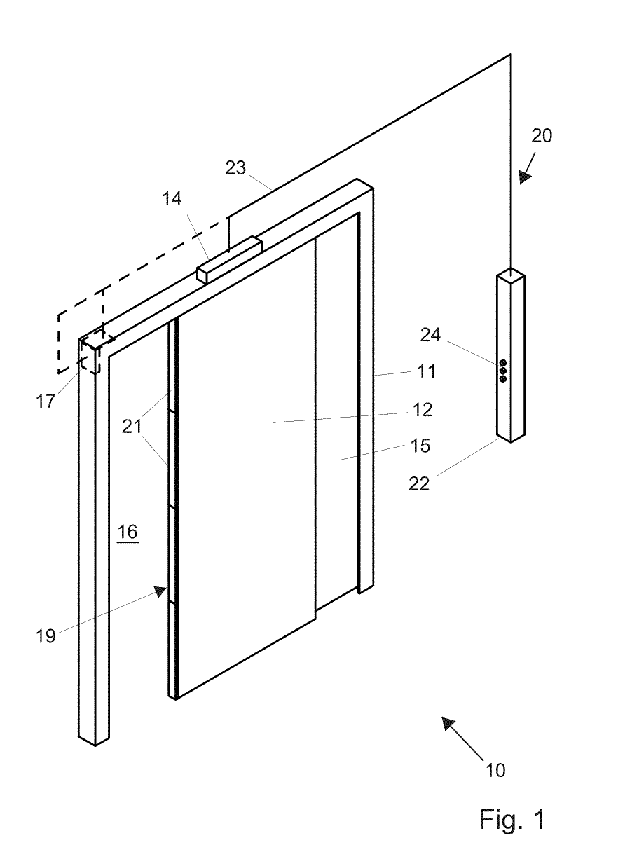

In FIG. 1, a sliding door 10 is shown, which comprises, in a frame construction 11, a mobile, door panel 12 standing upright, with a motor 14 driving the movement of the door panel 12 in a horizontal direction. The drive of the door by the motor 14 takes place as known in prior art as such, for example, by a linear or toothed belt drive. On the back of the door panel 12, the frame 11 of the sliding door of this embodiment includes a blind surface 15, which, when the door is in closed condition, closes the door area enclosed by the frame together with the door panel, and which, when the door is in open condition, is hidden by the door panel, while the actual door opening 16 is made accessible.

For the driving and controlling of the movement of the door panel 12, the door 10 is equipped with a control system 20. The control system 20 includes a sensor device 21, which is arranged on a front side 19 of the door panel 12. The term “front side” is meant to denote any surface or partial surface of the door panel that moves forward as a front surface with a closing movement of the door, thus forming a front surface area of the door panel; in the embodiment shown, the front side 19 is the so-called door edge, namely, the (here vertically oriented) slim side between both door panel surfaces, which are oriented toward the outside and inside, respectively. The sensor device 21 located on the front side 19 includes at least two sensor electrodes 31; in the example shown, four sensor electrodes.

The control system 20 also includes a control unit 22, which may be arranged separately from the door 10 (as indicated in FIG. 1) or may be housed in a section of the frame 11. The control unit 22 is connected with the motor 14 and the sensor device 21 via electrical lines 23, e.g. led in the overhead area in the door frame or outside of this. The control unit 22 shows an operating panel 24 with operating elements, via which a user can control the opening and closing of the door. The closing process, by means of sensor device 21, is monitored as to whether there is an obstacle within the door opening, such as, for example, a person, a body part (e.g. a finger), or an animal, that could be injured as a result of the closing movement. During the opening movements, the sensor device can remain passive; instead, if necessary, a second sensor device may be mounted on the opposite door edge to secure possible danger areas created by the opening movement, and in this case the remarks made for the sensor device of the door edge of the front surface of the closing movement apply mutatis mutandis.

Alternatively, the control unit 22 and the sensor device 21 may be connected with each other through wireless connections. This provision may obviate the need for connection cables or similar components between the door frame and the door panel, which could soon wear because of the movement. In this case, the electrical supply of the electrical components of the sensor device 21 may take place via a base station 17, which is located in the door frame, for example, in an upper corner of the door frame, preferably on the edge of the door opening. The base station 17 serves as the charging station for the sensor device when the door is in closed position, as well as wireless receiver for measurement signals from the sensor device when the door is in closed and open condition.

As can be seen in FIG. 2, which shows a front view of the door edge 19, the sensor device 21 shows a number of sensor electrodes 31, which are arranged next to one another, preferably on top of one another and/or next to one another, as well as adjacent electrodes lying next to one another in pairs or groups arranged on top of one another. The number of sensor electrodes is at least two, preferably more than two, for example, three, four, or more. An even number—for example, four, six, or eight—may be favorable, because this allows for the pairwise wiring of the sensor electrodes.

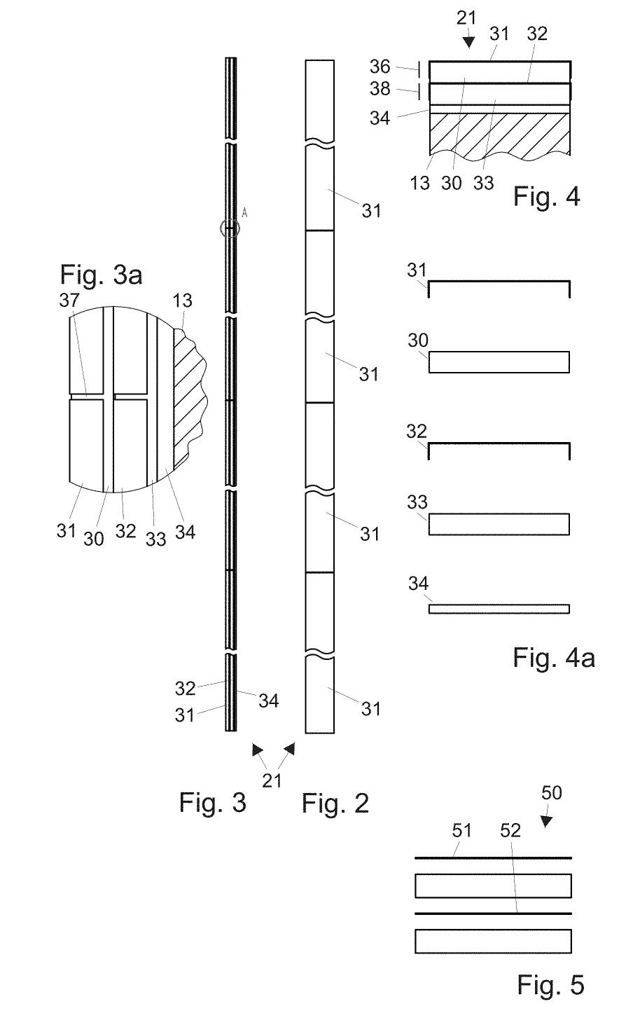

Using FIGS. 3, 3a, 4, and 4a, the structure of the sensor device 21 which in the embodiment shown realizes a layer structure, is visible. The sensor electrodes 31 are applied to a carrier body 30, which here, at the same time, has an insulating layer, for example of polyethylene, presented for the sensor electrodes, and the sensor electrodes are insulated against the body 13 of the door panel. The sensor electrodes 31 are, for example, realized as a thin film, with a thickness of a few tenths of a millimeter, e.g. 0.018 to 0.5 mm, or a plate up to a thickness of 2 mm. The sensor electrodes 31 are separated from one another and arranged next to one another and/or above one another on the door edge 19, or, more precisely, to their common carrier body 30, so that, between any two sensor electrodes 31, there is a gap 37.

Referring to FIG. 4, the sensor electrodes 31 may project as extensions of their frontal main surface laterally over the edges of the front surface and cover a small edge area 36 of the door surface. They thus show an L or a U form, according to whether they show an adjacent edge area 36 on one or both sides of the door surface. The sensor electrodes 31 also comprise contact points (not shown), via which the sensor electrodes are connected to electrical lines in a usual manner, which are led through the interior of the carrier body 30 and, for example, to the upper side of the sensor device to the connection with the control unit 22.

Electronic components may be housed in the carrier body 30 as well; for example, in the case of a wireless connection to the control unit 22 in the carrier body, measurement devices are provided that measure the capacitance values and then send the signals derived to the control unit wirelessly. With a wired connection, the measurement of the capacitances in the measurement devices may take place in the door panel or directly in the control unit 22.

The sensor device according to the invention may also include one or more guard electrodes. The guard electrodes 32 are arranged between the sensor electrodes 31 and the door body 13 and serve the capacitive decoupling between the sensor electrodes and the potential of the door body 13, which normally corresponds to the ground potential. In the embodiment shown, the guard electrodes 32 are configured in such a way that they correspond to the sensor electrodes 31 in number and in surface distribution. In other embodiments, joint guard electrodes of the sensor electrodes may be provided; in particular, one unique common guard electrode may be implemented.

The guard electrodes 32 may, for example, be realized as a thin film, with a thickness of a few tenths of a millimeter, e.g. 0.018 to 0.5 mm, or as a plate with a thickness of up to 22 mm. The guard electrodes 32 are attached on a second carrier body 33, e.g. likewise made of polyethylene, which at the same time serves as an insulating layer toward the door panel body 13. The individual guard electrodes 32 are separated from one another in the embodiment shown, and—in a type corresponding to the sensor electrodes 31—are arranged next to or on top of each other on their common carrier body 33. On the guard electrodes 32, again, is found the above-mentioned carrier body 30 of the sensor electrodes. The carrier body 33 of the guard electrodes is attached to the body 13 of the door panel on its front side by means of a carrier element 34. The carrier element 34 provides mechanical adjustment between the sensor device 21 and the door panel body 13 and is, for example, a rectangular, strip-type component made of an electrically insulating, mechanically firm plastic material. In simplified embodiments, the carrier body 33 may be directly connected with the door panel body 13 or, at the same time, may serve itself as the carry element for the door panel body 13.

The connection between the components/layers is realized by adhesive in the embodiment shown, but in other variants it may be achieved through different suitable means of connection, such as screws, rivets, tape, clamps, retaining straps or film, etc.

The guard electrodes 32 may, from an electrical standpoint, suitably be controlled guard electrodes, which in each case are supplied with the same alternating voltage as the capacitive sensor electrodes. The guard electrodes 32 are, for example, connected to the control unit 22 via (not shown) contact points and electrical lines, which are led through the interior of the carrier body 33, for example, to the upper side of the sensor device.

The guard electrodes 32 separate the sensor electrodes 31 and the door panel 31 spatially and thus also electrically. The form of the guard electrode(s) 32 may, for example, be of such a way that they project to the side via their front-oriented main surface and cover a small edge area 38 of the door surface, such that they show an L or a U form, according to whether they run over the edge on one or both edges.

In other variants, a guard electrode may also partially surround the appropriate capacitive sensor electrode(s), for example, in trench-like or cup-like shape. In addition, the guard electrode may be provided with embouchures protruding or sticking out from the side.

On the part of the control unit, there is a continuous, that is, several times per second, preferably 50 times to 250 times per second, determination of the values of the capacitances of each individual sensor electrode 31 to the ground and under one another, as well as, if necessary, the capacitance change between the individual sensor electrodes 31 and the appropriate guard electrode(s) 32. For this, measurement devices for the determination of the capacitance according to known practice are provided in the sensor device 21 and/or the control unit 22. An obstacle that is found in front of the sensor device 21 in general creates a very large capacitance change of the sensor electrodes with regard to ground potential, nevertheless one that is very small or not in reference to the guard electrodes, while water effects a strong capacitance change of the sensor electrodes on a sensor electrode against the guard electrodes. An obstacle found in front of the sensor electrode effects a large capacitance change between the sensor electrode and the ground, and even in the opposite direction of the capacitance change between the sensor electrodes and the guard called up by water, allowing to recognize an obstacle well even in the case that the sensor electrodes are connected with water. The change brought about by water can thus be recognized by its sign, in order to exclude the evaluation as an obstacle.

Because the sensor electrodes 31 extend over a considerable length and due to the fact that according to the invention at least two sensor electrodes 31 are used for a comparison measurement of their potentials, a concordant potential change to two sensor electrodes as the trigger for the generation of a stop signal for the motor of the motorized sliding door can be disregarded. The generation of a signal to stop the motor can take place only when there is actually a person in the area of the sensor electrodes 31 and thus causes different potential changes in the relevant sensor electrodes 31. In this way, the system must be seen as largely insensitive as regards influences such as humidity or dirt.

For example, the sensor device in FIG. 2-4 may have the following dimensions: starting from a door thickness of, for example, 50 mm (=width of the door front surface), the carrier body 30, 33 have the same width, as well as a length that corresponds overall to the height of the door panel, e.g. 2085 mm. With an embodiment having four sensor electrodes up to 0.3 mm, these have a size of 50.6 mm×520 mm, with a width of the gap 37 of 1 mm. With higher or lower door panels, the heights of all or of individual sensor electrodes may be varied as suitable. The thickness of the carrier body 30, 33 is, for example, 7.5 mm, of which 6 mm is covered by the side expansions of the electrodes.

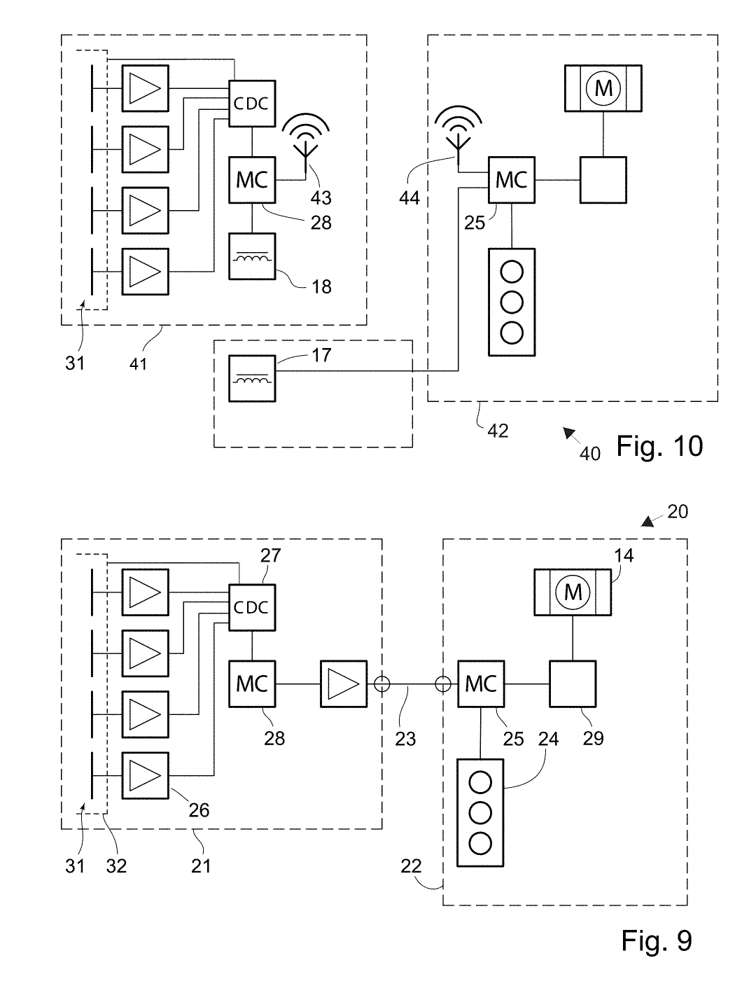

FIG. 9 shows a schematic wiring diagram in block diagram form of the control system 20. The capacitive sensor electrodes 31 arranged in the sensor device 21 on the door panel 12 are symbolized in the left area of the figure by vertical lines and work toward ground potential (not shown). The shield by the guard electrode 32 is indicated by a dotted line in the wiring diagram. The sensor device 21 or the sensor electrodes 31 is/are connected to the control unit 22 via electrical lines, as mentioned. The control unit 22 contains a central computing element 25, which, for example, is designed as a microcontroller (MC) and which accepts received signals from the sensor unit 21, and these in accordance with commands which can be entered by the user on the operating panel 24, processed, and thus controlled with the motor 14 of the door (for example via a power amplifier) to open and to close the door. To oversee the movement of the door, in particular, a closing movement, the signals of the sensor electrodes 31 are led via the amplifier 26 and the converter 27 for the conversion of the measured capacitances to digital signals (CDC, for “Capacitance to Digital Converter”) to a microcontroller (MC) 28 of the sensor device and offset. The capacitance values thus transmitted (if suitable by means of drivers) are led via the lines 23 to the computing unit 25 to the control unit. The central computing unit 26 can thus continually oversee the measurement values of the sensor electrodes 31. If a change of the capacitances or a capacitance difference is determined via a threshold value, a closing movement of the motor 14 is blocked; likewise, a reverse movement can also be introduced, for example, to a pre-programmed return path of just a few millimeters. The threshold value depends on the local conditions and, in linear fashion according to the relationship of the local disruptions immediately after the assembly, is adjusted to a size established for each door type on the basis of type measurements and is programmed lastingly in the computing unit. The control system 20 may also comprise further sensors, which, for example, monitor the locked status of the door or other parameters, but this nevertheless is not the object of this invention.

An example for a wireless variant of the control system 40 is shown in FIG. 10. In this case, the exchange of information between the sensor device 41 and the control unit 42 takes place via a radio connection, which is symbolized in FIG. 10 by antenna 43, 44. The sensors 31 are connected with the microcontroller 28 of the sensor device 41 in the same way as described in the previous embodiment of FIG. 9, from where the determined values of the capacitances and/or capacitance differences thus determined are sent by the radio connection to the control unit 42, where the further processing of the measurement values takes place in the form described in FIG. 9. A power supply 18, which works together with a base station 17 in the frame construction 11, serves the energy supply of the electrical components of the sensor device 41. The power supply 18 and the associated base station 17 are, for example, attached in the area of the upper corner of the door opening 16 and, with closed doors, come together in inductive or galvanic contact, so that in closed condition, an energy storage system contained in the power supply can be loaded; in this way, operation is ensured in open as well as in partially open condition.

In addition, in particular in the case of a wireless control system 40, it may be provided that the base station 17 sends a signal to the sensor device 41 at the beginning and at the ending of each door movement, for example, in the form of a radio or infrared signal. This signal is received by the power supply 18; in the case of an infrared signal, the power supply 18, for example, may include a photo cell, with which the electrical energy is achieved from the signal at the same time. The wirelessly (e.g. using an infrared or radio signal) transmitted energy may also be used to “wake up” and to operate the electronics of the sensor device 41, in particular their wireless transfer part. At the end or after the door movement, the sensor device is again deactivated, such that it rests and uses as little energy as possible, or no energy at all. Thus, the sensor electronics, in particular their wireless transfer part, needs only little energy while the door is open; the energy storage system remains charged and is available for the next movement, even if this does not take place after some time, for example, after days or weeks.

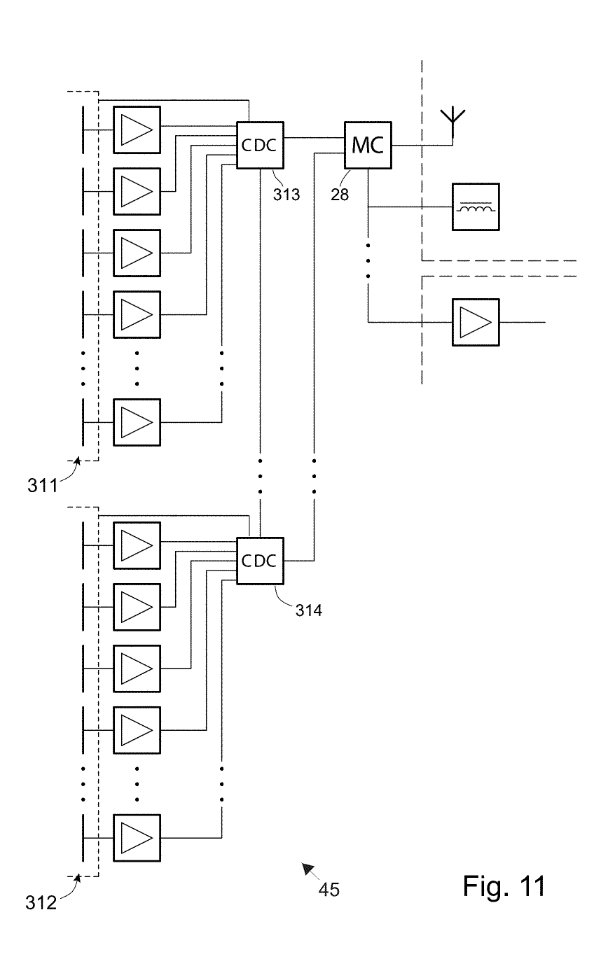

FIG. 11 shows a wiring diagram of a variant 45 of the sensor device with several groups 311, 312 of sensor electrodes whose measurement signals are calculated in their own CDC 313, 314 of each electrode group and from there are forwarded to the microcontroller 28, which forwards these wirelessly or via electrical lines to the control unit 22 as already described.

The exploded view of FIG. 5 illustrates a variant 50 of the sensor device, in which the sensor and guard electrodes 51, 52 are formed as flat elements without side extensions to the front or the rear. This layout simplifies the production of the sensor device, in case of, if necessary, higher susceptibility with regard to disruptions such as stray capacitances.

The number and the dimensioning of the sensor and guard electrodes may vary and may be adjusted according to the offered use. For example, as shown, the electrodes may be realized as elongated rectangles with a side ratio suitably selected, but also as squares, or as multiple squares. The surfaces of the sensor and guard electrodes may cover the entire front surface of the door panel, or only a part of this, or only a part of its width.

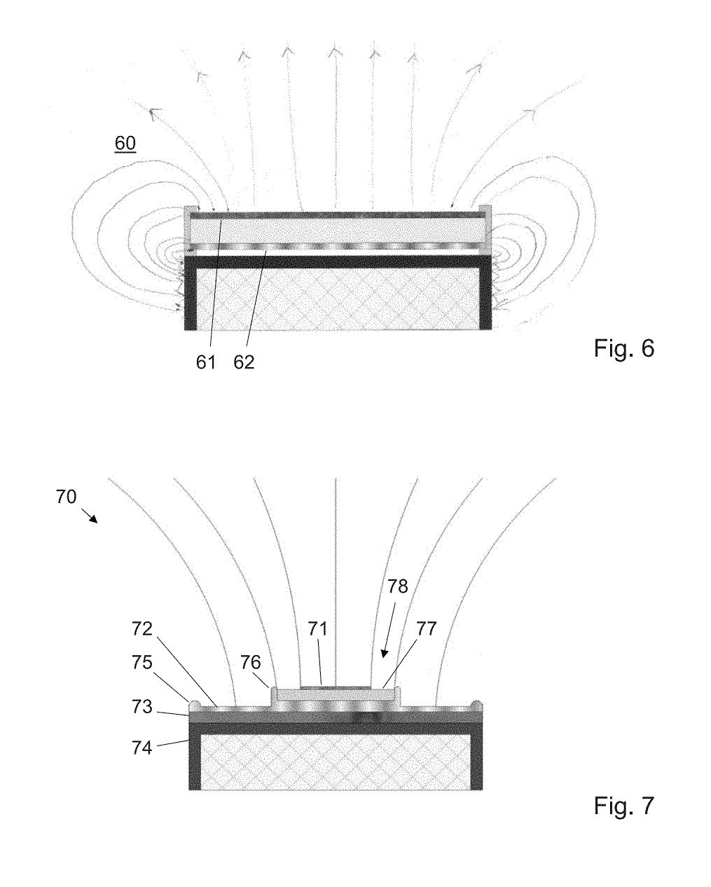

In the sectional view of FIG. 6 (section along the horizontal), for example, one further variant, the field line 60 as well as the sensor electrode 61, as well as the guard electrode 62 are presented. It can be seen that the field lines that originate from the capacitive guard electrodes 62 lead to an isolation of the field lines, which emanate from the sensor electrodes 61. Thereby, the capacitive field of the sensor electrodes 51 are clearly less sensitive toward disruptions that are irrelevant for the safety of the oversight of the closing movement of the motorized sliding door.

FIG. 7 shows a sectional view of a further embodiment 70 of the invention, in which the guard electrode 72 shows separating elements 75, 76 configured as a rail or protrusion, which serves the better electrical and electromechanical delimitation of the sensor electrode 71 attached in the middle. The sensor electrode 71 is arranged on an electrically insulating carrier material 77 within the grooved structure 78, which is formed from two rails 75 of the guard electrode 72, which surround the carrier material 77 on both sides. Even in this embodiment, the guard electrode 72 is electrically separated from the body 74 of the door panel by an insulating level 73. The guard electrode 72 shows, in its middle area—which corresponds to a vertically running middle strip from the front surface of the door panel—the mentioned structure 78.

Both edges of the guard electrode are preferably realized as protruding bands. In similar fashion, the bands 75 on one side preferably form a section with the outer surface of the guard electrode 72; on the other side, the band 75 preferably protrudes over the surface of the carrier material 77. In this way, the bands 75, 76 form structures that interrupt a possible film of water or dirt, which might otherwise create electrical bridges between the electrodes and/or the door panel. For example, it may be the case that a drop of water (or a film of water or dirt) on the front of the door panel will arise and, hereby, reach over the edge of the sensor electrode 75 up to the guard electrode 76, which would lead to the short circuit of the sensor and guard electrodes 71, 72. The band 75 divides the drops (or film) and thus works as a separating element that interrupts the contamination-related electrical connection between the electrodes. In similar fashion, the band 76 interrupts a connection between the guard electrode 72 and the door panel body 74 arising as a result of water or dirt. In this way, the susceptibility to failure toward spray water, rain, etc., is clearly lessened.

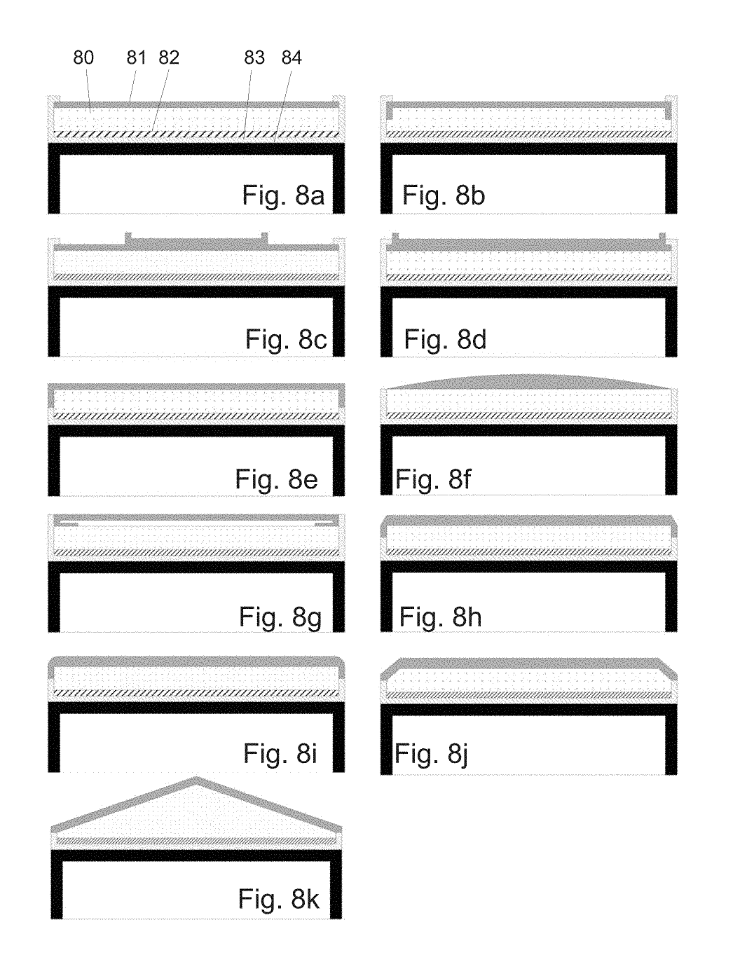

In FIGS. 8a to 8k, further exemplary embodiments of the configuration of the sensor and guard electrodes are presented, in each case in a sectional view along the horizontal. In this, FIG. 8a corresponds to the configuration of FIG. 6. In these figures, the components are presented by shading in each case. The embodiments of FIG. 8a-8k are differentiated in the first by the shape of the sensor electrode 81, while the guard electrode 82 may be carried out preferably as a planar layer; however, if necessary, it may also have another (not shown) form. The carrier layer 80 and the carrier component 83 serve the electrical insulation as well as mechanical stabilization of the electrodes. The connection layer 83 also serves the affixing of the sensor device on the door panel body 84 as well as its lateral delimitation.

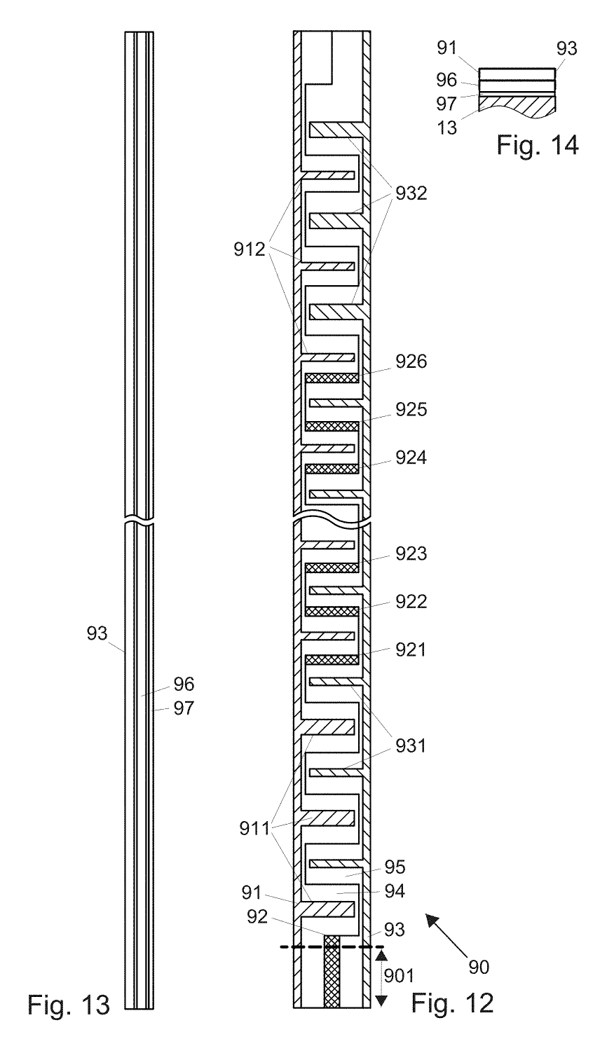

In FIGS. 12 to 14, another embodiment of a sensor device 90 is presented, in which, thanks to an advantageous geometric distribution of the front surface for the sensor electrodes, a particular resistance to interference toward external electromagnetic influences is achieved. Thanks to the shape of the sensor electrodes with different forms from one another, the sensitivity toward external disruptions can be clearly reduced.

The sensor device 90 contains, for example, three sensor electrodes 91, 92, 93, which all extend along the entire height of the door edge and are realized as strips arranged side by side with variable width and/or with electrode surfaces at different heights of the door edge. In this way, the irradiation of interferences or like influences, because of the electrodes working as antennas, can be better compensated, so that the sensor device 90 is overall less prone to failure from external irradiations. Here, both external electrodes 91, 93 (left or right) also in particular serve to detect incoming obstacles from the side. To also detect such an obstacle, which is found exactly in the middle in front of the sensor device, in particular when it does not extend across the entire length of the door edge, it is favorable if the side sensor electrodes 91, 93 are asymmetrical along their lengths and/or are completed with at least one sensor electrode 92 arranged in between, which is likewise unsymmetrically formed along the length. This ensures that on one hand the sensor electrodes 91, 92, 93 have the same capacitance, while on the other hand, these capacitances are distributed differently over the length of the sensors. Thus same overall field areas of the electrodes are obtained, which, however, are different in the individual sections of the sensor device, and which react in different ways in case of a disruption by an obstacle, and thus deliver a measurable signal. In this way, the smallest obstacles can be recognized just as well as larger ones in any position, lateral as well as directly in front of the sensor device.

Between the sensor electrodes 91, 92, 93, free areas 94, 95 may be present, in which the carrier material of the electrodes is uncovered, or the guard electrode 96 lying thereunder is visible. The sensor electrodes 91, 92, 93 may be realized in comb-like and/or in meander fashion, to achieve a distribution in several partial surfaces, which are preferably arranged in each case in different areas of the door edge (that means, at different height areas). For example, the first sensor electrode 91 includes several electrode surfaces 911, 912, wherein the (e.g. three) electrode surfaces 911 in one lower area of the door edge are, for example, wider than the other electrode surfaces 912; the third sensor electrode 93 correspondingly includes several electrode surfaces 931, 932, wherein the (e.g. three) electrode surfaces 932 in an upper area of the door edge are, for example, wider than the other electrode surfaces 931. Thus, the external sensor electrodes 91, 93 are equipped with strips 911, 912, 931, 932 pointing towards one another, and which in each case may have the same width or (as shown in FIG. 12) may have different widths. Between the external electrodes 91, 93, (at least) one central electrode 92 is provided, which preferably runs in meander fashion and, for example, encompasses several electrode surfaces 921, 922, 933, . . . 924, 925, 926 in the central area of the door edge. Between the electrode surfaces, the sensor electrodes have a low width; they are preferably slim, that is, their width is negligible.

Referring to FIGS. 13 and 14, the sensor device 90 has a layer structure similar to that which is described further above with FIGS. 3 and 4. In particular, the sensor electrodes 91, 92, 93 may be mounted on a carrier body and arranged via a common guard electrode 96 whose carrier body is in turn attached to the body 13 of the door panel using a carrier element 97. In FIG. 13, using the example of the third sensor electrode 93, it can also be seen that, even here, the sensor electrodes project over the front main surface on the side over the edges of the front surface and may cover a small edge area of the door surface.

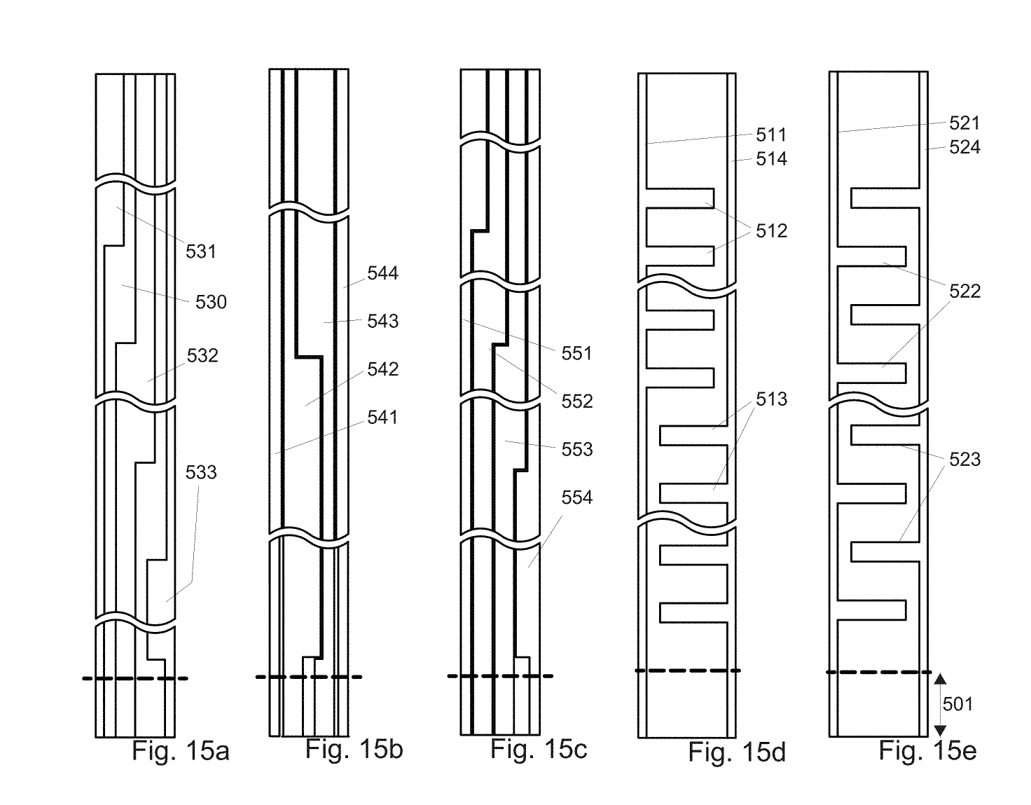

In FIGS. 15a to 15e, further exemplary geometric configurations of the sensor electrodes are shown.

FIG. 15a shows a configuration with three strip-shaped sensor electrodes 531, 532, 533 non-symmetric along their length, but overall of the same size. FIG. 15b shows a configuration with four sensor electrodes 541, 542, 543, 544, whereby both external electrodes 541, 544 show the same width; the electrodes 541 and 544 or 542 and 543 show in each case the same square measure. FIG. 15c shows a further configuration with four sensor electrodes 551-554, whereby, here, the electrodes show the same surface. Between the sensor electrodes wide unoccupied areas 530 may be left out (FIG. 15a), whose surface, for example, largely corresponds to those of the electrodes, or the electrodes may be separated by merely slim columns (FIG. 15b, 15c).

FIG. 15d and FIG. 15e show two further configurations of (external) sensor electrodes 511, 514, 521, 524, which in each case show further partial electrode surfaces 512, 513, 522, 523 in the form of stripes directed toward one another, whereby they are unsymmetrical in length. In FIG. 15d, the partial surfaces 512, 513 are arranged in groups, which correspond in various heights, while, in FIG. 153, the partial surfaces 522, 523 interlock in comb-like fashion. Because of this distribution of the partial surfaces of the sensor electrodes, the sensor electrodes comprehend a less uniform field area, which is influenced more strongly by small obstacles than is the case for the geometries of FIGS. 15a to 15c. Between the external sensor electrodes 511 and 514 or 521 and 524, (not shown) one or more central sensor electrodes may be provided where suitable.

Furthermore, the sensors of the types illustrated in FIGS. 12 to 15e can also be adjusted in length to a (maximum) of the dashed lines on the doors, because in the end areas 901, 501 the portions of the sensor electrodes below these dashed lines are the same size, and shortening the lengths will not change the mutual relationship of capacitances of the sensors (or not substantially). The maximum shortening amount may be provided on the lower end area 901/501 and/or on the upper end area according to the configuration of the sensor device.

Of course, the invention is not limited to the embodiments shown here and still many further embodiments are possible under the framework of the invention, insofar as these fall under the scope of protection of the following claims.

1. Method for controlling a door, in particular a sliding door comprising:
Driving a door having at least one panel by a motor, wherein the at least one panel further comprises at least two capacitive sensor electrodes arranged on a front surface thereof.
Detecting the capacitance of the at least two capacitive sensor electrodes independently from one another with respect to a common reference potential, preferably ground potential; and
Generating a signal to stop the motor driving the door upon detecting a change of capacitance on at least one of the sensor electrodes in comparison with at least one other sensor electrode.

2. The method of claim 1, wherein the capacitive sensor electrodes are spatially and electrically separated from the door panel by at least one controlled guard electrode.

3. The method of claim 2, wherein the guard electrode is operated with the same phase and amplitude as the sensor electrodes, preferably by the same source.

4. The method of claim 1, further comprising wireless transmission of signals, wherein, a sensor device disposed on a portion of the door panel, wherein the sensor device wirelessly transmits signals of the capacitive sensor electrodes with regard to capacitances and/or capacitance differences to a control unit configured to control the motor, and wherein, at the beginning and at the end of a door movement of the door, control signals are transmitted to the sensor device, and by means of said control signals the sensor device is activated for the duration of the door movement.

5. Control system for the control of a door driven by a motor, in particular sliding doors, comprising:
at least two capacitive sensor electrodes, which are provided on a front surface of a door panel of the door;
a control unit, which is configured to compare measured values of capacitances detected by means of the sensor electrodes independently from one another with respect to a common reference potential, preferably ground potential, and to generate, upon detecting a capacitance difference on at least one of the sensor electrodes in comparison to at least one further sensor electrode and
a signal to stop the motor.

6. The control system of claim 5, wherein the capacitive sensor electrodes are spatially and electrically separated from the door panel and at least one controlled guard electrode is provided between the sensor electrodes and the door panel.

7. The control system of claim 6, characterized in that at least one controlled guard electrode is separated from the sensor electrodes and the door panel by an insulation and preferably has a shape partially surrounding the sensor electrode(s).

8. The control system of claim 6 wherein the guard electrode comprises edges protruding from the side and/or strips protruding from the edges.

9. The control system of claim 5, wherein the control unit is also arranged to differentiate between the presence of water on a sensor electrode from an obstacle present in front of the sensor electrodes on the basis of the capacitance change.

10. The control system of claim 5, characterized in that the capacitive sensor electrodes in a sensor device on the front surface are arranged on top of one another as strips separated from one another made of conductive material, preferably metal, on an insulating layer, in particular on an insulating layer made of Teflon or an epoxy resin with a glass fabric insert, wherein the sensor device encompasses a carrier element, on which the sensor electrodes as well as, if applicable, the guard electrode are positioned in a predetermined arrangement, and which is attachable for mounting on the front surface of a door panel.

11. The control system of claim 5, further comprising a sensor device provided on the door panel, said sensor device being connected with the control unit via a wireless interface, via which values of capacitances and/or capacitance differences detected by the sensor device are transmitted wirelessly, wherein, preferably, the energy supply of the sensor device is realized via the wireless interface, for example, via a radio or infrared signal.

12. The control system of claim 5, wherein the sensor electrodes extend beyond one or both of the side edges of the front surface, namely, in a particular edge area of one door surface adjacent to the front surface.

13. The control system of claim 5, wherein the sensor electrodes run over the entire height of the front surface, wherein each of the sensor electrodes has a width varying along the height and in a different way than the other sensor electrodes.

14. The control system of claim 5, wherein the sensor electrodes run over the entire height of the front surface, wherein in each of the sensor electrodes small areas with negligible width alternate with at least two electrode surfaces.

15. The control system of claim 5, wherein in at least one end area of the front surface the sensor electrodes are of the same width, allowing for a shortening of the sensor electrodes.
